(19) United States
(12) Patent Application Publication
(10) Pub. No.: US 2018/0283544 A1
(43) Pub. Date: Oct. 4, 2018

(54) Shift Lever Device

(71) Applicant: FUJI KIKO CO., LTD., Shizuoka (JP)

(72) Inventor: Yoshihiro TAKIKAWA, Shizuoka (JP)

(21) Appl. No.: 15/939,755

(22) Filed: Mar. 29, 2018

(30) Foreign Application Priority Data
Mar. 29, 2017 (JP) 2017065137

(51) Int. Cl. F16H 61/24; F16H 59/10

(52) U.S. Cl. CPC F16H 61/24; F16H 2059/026; F16H 59/10

(57) ABSTRACT

The shift lever device includes a housing and a shift lever. The housing is separable in the right-left direction at connecting walls. The connecting wall has a fitting portion which protrudes from one of the pair of right and left side walls toward the other side wall and a fitting tube portion which protrudes from the other side wall toward the one side wall and into which the fitting portion is fitted. The fitting portion has a fitting-portion main part and an inner fitting part extending inward of the housing from the fitting-portion main part. The fitting tube portion has a fitting-tube-portion main part into which the fitting-portion main part is fitted, and an inner fitting tube part which extends inward of the housing from the fitting-tube-portion main part and into which the inner fitting part is fitted.

### CROSS REFERENCE TO RELATED APPLICATION

The present application is based on, and claims priority from Japanese Patent Application No. 2017-065137, filed Mar. 29, 2017, the disclosure of which is hereby incorporated by reference herein in its entirety.

### TECHNICAL FIELD

The present invention relates to a shift lever device.

### BACKGROUND ART

Conventionally, a shift lever device for operating the automatic transmission of a vehicle has been known.

A shift lever device of this type includes a housing adapted to be fixed to the body of the vehicle and a shift lever swingably supported by the housing. In some of such shift lever devices, the housing is separated into two housing pieces in the right-left direction, and a shift lever is supported between the two housing pieces, which are joined together (for example, see Patent Literature 1: Japanese Patent Application Publication No. 2013-199221).

### SUMMARY

In a shift lever device disclosed in Patent Literature 1, both housing pieces are joined using protrusions and clips. However, there is a problem that it is difficult to obtain sufficient rigidity of the housing only by means of joining using the protrusions and the clips.

In view of the above, an object of the present invention is to provide a shift lever device in which the housing supporting the shift lever has sufficient rigidity in the case where the housing is separated into two pieces in the right-left direction.

A shift lever device according to the present invention includes a housing adapted to be fixed to a body of a vehicle and a shift lever swingably supported by the housing. The housing has a pair of right and left side walls disposed in parallel and a pair of front and rear connecting walls connecting front portions and rear portions of the pair of right and left side walls, and is separable in a right-left direction at the connecting walls. The connecting wall has a fitting portion which protrudes from one of the pair of right and left side walls toward the other side wall and a fitting tube portion which protrudes from the other side wall toward the one side wall and into which the fitting portion is fitted. The fitting portion has a fitting-portion main part and an inner fitting part extending inward of the housing from the fitting-portion main part. The fitting tube portion has a fitting-tube-portion main part into which the fitting-portion main part is fitted, and an inner fitting tube part which extends inward of the housing from the fitting-tube-portion main part and into which the inner fitting part is fitted.

A shift lever device according to the present invention provides sufficient rigidity for the housing supporting the shift lever in the case where the housing is separated into two pieces in the right-left direction.

### BRIEF DESCRIPTION OF DRAWINGS

FIG. 1 is an exploded perspective view of a shift lever device according to an embodiment of the present invention.

FIG. 2 is a schematic cross-sectional view illustrating a state where a front fitting portion is fitted into a front fitting tube portion.

FIG. 3 is a cross-sectional view illustrating another embodiment of the present invention, which corresponds to FIG. 2.

FIG. 4 is a cross-sectional view illustrating another embodiment of the present invention, which corresponds to FIG. 2.

### DESCRIPTION OF EMBODIMENTS

Hereinafter, an embodiment of the present invention will be described in detail with reference to the drawings.

A shift lever device 1 according to this embodiment, when a shift lever (not illustrated) is displaced to multiple positions set in the swing range, switches an automatic transmission (not illustrated) to predetermined ranges corresponding to the positions.

Note that hereinafter descriptions on the front-rear direction, the right-left direction, and the up-down direction will be made with reference to a housing 2. In the drawing, arrow FR indicates the forward direction, arrow RR indicates the rearward direction, arrow RH indicates the right direction, arrow LH indicates the left direction, arrow UPR indicates the upward direction, and arrow LWR indicates the downward direction.

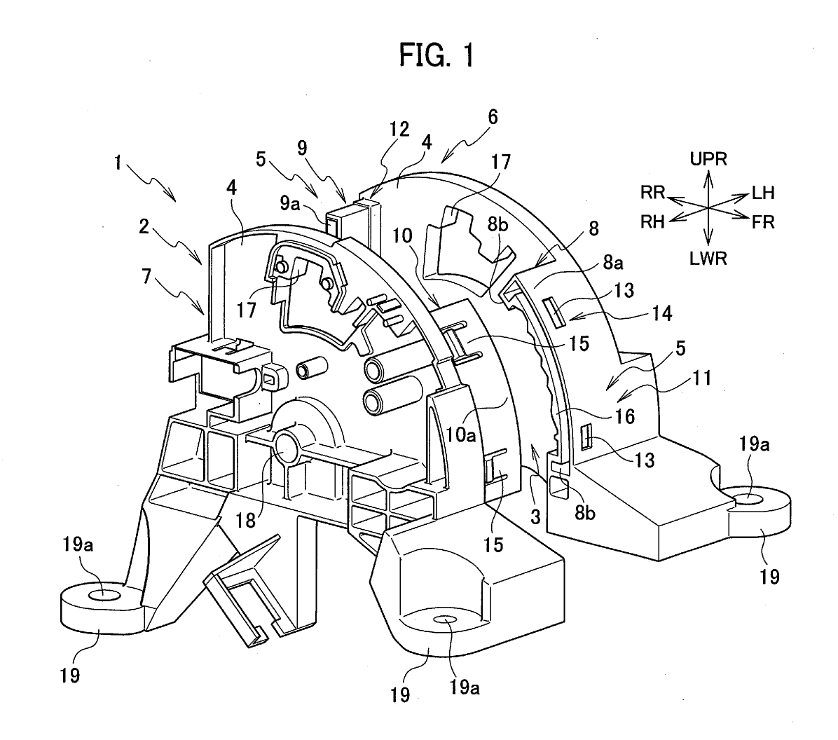

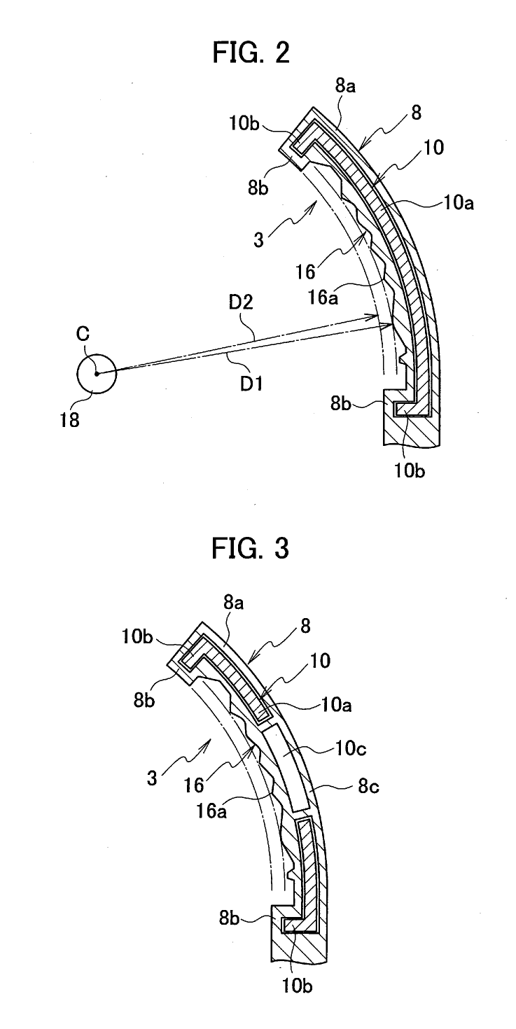

As illustrated in FIGS. 1 and 2, the shift lever device 1 includes the housing 2 to be fixed to the body of a vehicle (not illustrated) and a shift lever swingably supported by the housing 2. The shift lever device 1 also includes a check mechanism 3 which is disposed between the housing 2 and the shift lever and provides a tactile feel to each of the positions set within the swing range of the shift lever when the shift lever is swung.

The housing 2 has a pair of right and left side walls 4, 4 disposed along the front-rear direction and in parallel to each other and a pair of front and rear connecting walls 5, 5 disposed along the right-left direction and connecting front portions and rear portions of the pair of right and left side walls 4, 4. This housing 2 has a rectangular tube shape having a rectangular cross section opening in the up-down direction. Specifically, the pair of right and left side walls 4, 4 are connected at the front portions by the front connecting wall 5 and connected at the rear portions by the rear connecting wall 5. In addition, the housing 2 is separable into two pieces, a left housing 6 and a right housing 7, in the right-left direction at the connecting walls 5, 5.

The left housing 6 includes a left side wall 4, a front fitting tube portion 8 which is part of the front connecting wall 5, and a rear fitting portion 9 which is part of the rear connecting wall 5. On the other side, the right housing 7 includes a right side wall 4, a front fitting portion 10 which is part of the front connecting wall 5, and a rear fitting tube portion (not illustrated) which is part of the rear connecting wall 5. Then, the front fitting tube portion 8 and the front fitting portion 10 constitute a front fitting structure 11 which is a fixing portion of the left housing 6 and the right housing 7 at the front. On the other side, the rear fitting portion 9 and the rear fitting tube portion constitute a rear fitting structure 12 which is a fixing portion of the left housing 6 and the right housing 7 at the rear. Note that although in the rear fitting structure 12, the left housing 6 has the rear fitting portion 9 and the right housing 7 has the rear fitting tube portion, the left housing 6 may have a rear fitting tube portion and the right housing 7 may have a rear fitting portion.

The front fitting tube portion 8 protrudes from a front portion of the left side wall 4 toward a front portion of the right side wall 4 and has a tube shape opening to face the right housing 7. The front fitting tube portion 8 is configured such that the front fitting portion 10 is fitted into the front fitting tube portion 8. The front fitting tube portion 8 has a fitting-tube-portion main part 8a extending along an outer edge of the housing 2, and inner fitting tube parts 8b extending inward of the housing 2 from both ends of the fitting-tube-portion main part 8a. Fitted into the fitting-tube-portion main part 8a is a fitting-portion main part 10a to be described later, and fitted into the inner fitting tube parts 8b are inner fitting parts 10b to be described later. The front fitting tube portion 8 also has a lock hole 13.

The front fitting portion 10 protrudes from a front portion of the right side wall 4 toward a front portion of the left side wall 4 and is configured to be fitted into the front fitting tube portion 8. The front fitting portion 10 has the fitting-portion main part 10a extending along an outer edge of the housing 2, and the inner fitting parts 10b extending inward of the housing 2 from both ends of the fitting-portion main part 10a. The fitting-portion main part 10a is adapted to fit into the fitting-tube-portion main part 8a, and the inner fitting parts 10b are adapted to fit into the inner fitting tube parts 8b. The front fitting portion 10 also has a lock tub 15 which, together with the lock hole 13, constitutes a lock structure 14.

Disposed between the inner fitting tube parts 8b formed at both ends of the fitting-tube-portion main part 8a are check protrusions 16 constituting the check mechanism 3. The check protrusions 16 are formed such that peaks 16a are located at outer positions of the housing 2 than the inner fitting tube parts 8b of the front fitting tube portion 8. Thus, distance D1 from the swing pivot C of the shift lever to the peaks 16a of the check protrusions 16 is larger than distance D2 from the swing pivot C of the shift lever to the inner fitting tube parts 8b of the front fitting tube portion 8 (see FIG. 2).

The rear fitting portion 9 protrudes from a rear portion of the left side wall 4 toward a rear portion of the right side wall 4 and is configured to be fitted into the rear fitting tube portion. The rear fitting portion 9 has a fitting-portion main part 9a extending an outer edge of the housing 2. The fitting-portion main part 9a of the rear fitting portion 9 is adapted to be fitted into a fitting-tube-portion main part of the rear fitting tube portion. Note that in the same manner as in the front fitting portion 10, inner fitting parts may be formed continuously from the fitting-portion main part 9a of the rear fitting portion 9.

The rear fitting tube portion protrudes from a rear portion of the right side wall 4 toward a rear portion of the left side wall 4 and is configured to be fitted over the rear fitting portion 9. The rear fitting tube portion has the fitting-tube-portion main part extending along an outer edge of the housing 2. Then, the fitting-tube-portion main part of the rear fitting tube portion fits over the fitting-portion main part 9a of the rear fitting portion 9. Note that in the same manner as in the front fitting tube portion 8, inner fitting tube parts may be formed continuously from the fitting-tube-portion main part of the rear fitting tube portion.

In addition, formed to be open at upper portions of the left side wall 4 and the right side wall 4 are detent holes 17, and formed to be open at lower portions of the left side wall 4 and the right side wall 4 are shaft support holes 18. The detent holes 17 have multiple pits and projections corresponding to the range pattern of the automatic transmission. The pits and projections of the detent holes 17 are engaged with a position pin integrated in the shift lever and restricts the swing movement of the shift lever. The shaft support holes 18 are circular through holes into which a support shaft of the shift lever can be inserted, and support the support shaft of the shift lever without looseness.

Further, fixing portions 19 are formed, each at a lower end of the rear edge of the right side wall 4 and at lower ends of the front edges of the left side wall 4 and the right side wall 4, three locations in total. Formed to be open in each fixing portion 19 is a fixation hole 19a passing through the fixing portion 19 in the up-down direction. The housing 2 is fixed to the vehicle by screwing bolts (not illustrated) inserted through these fixation holes 19a to the vehicle.

The shift lever has the support shaft in a cylindrical shape at the proximal end. Then, by the support shaft being supported by the shaft support holes 18 of the housing 2, the shift lever is pivotally supported by the housing 2 so as to be capable of swinging in the shift direction (the front-rear direction).

Hereinafter, the operation and effect of this embodiment will be described.

(1) The shift lever device 1 includes the housing 2 to be fixed to the body of the vehicle and the shift lever swingably supported by the housing 2. The housing 2 has the pair of right and left side walls 4, 4 disposed in parallel and the pair of front and rear connecting walls 5, 5 connecting front portions and rear portions of the pair of right and left side walls 4, 4 and is separable in the right-left direction at the connecting walls 5, 5. The connecting wall 5 has the fitting portion (front fitting portion) 10 which protrudes from one of the pair of right and left side walls 4, 4 toward the other side wall 4, and the fitting tube portion (front fitting tube portion) 8 which protrudes from the other side wall 4, 4 toward the one side wall 4 and into which the fitting portion 10 is fitted. The fitting portion 10 has the fitting-portion main part 10a and the inner fitting parts 10b extending inward of the housing 2 from the fitting-portion main part 10a. The fitting tube portion 8 has the fitting-tube-portion main part 8a into which the fitting-portion main part 10a is fitted and the inner fitting tube parts 8b which extend inward of the housing 2 from the fitting-tube-portion main part 8a and into which the inner fitting parts 10b are fitted.

Forming the inner fitting parts 10b on the fitting portion 10 (fitting-portion main part 10a) and forming the inner fitting tube parts 8b on the fitting tube portion 8 (fitting-tube-portion main part 8a) increase the contact surface between the fitting portion 10 and the fitting tube portion 8. This increases the fitting strength between the fitting portion 10 and the fitting tube portion 8, improving the rigidity of the housing 2.

Thus, the shift lever device 1 according to this embodiment makes it possible to provide the sufficient rigidity for the housing 2 supporting the shift lever in the case where the housing 2 is separated into two pieces in the right-left direction.

(2) The fitting-portion main part 10a and the fitting-tube-portion main part 8a extend along outer edges of the housing 2.

This configuration of the fitting-portion main part 10a and the fitting-tube-portion main part 8a provides a sufficient area of the contact surface between the fitting portion 10 and the fitting tube portion 8, increasing the fitting strength between the fitting portion 10 and the fitting tube portion 8.

(3) The inner fitting tube parts 8b are formed at both ends of the fitting-tube-portion main part 8a and the check protrusions 16 are disposed between these inner fitting tube parts 8b.

This configuration of the check protrusions 16 increases distance D1 (see FIG. 2) of the shift lever from the swing pivot C to the peaks 16a of the check protrusions 16, improving the flexibility in setting the operating force of the shift lever.

Incidentally, although the shift lever device of the present invention has been described using the above embodiment as an example, the present invention is not limited to this embodiment. Various other embodiments may be adopted without departing the gist of the present invention.

For example, as illustrated in FIG. 3, the configuration may be such that an intermittent portion 8c is formed at an intermediate portion of the fitting-tube-portion main part 8a in the front fitting tube portion 8, and an intermittent portion 10c is formed at an intermediate portion of the fitting-portion main part 10a in the front fitting portion 10.

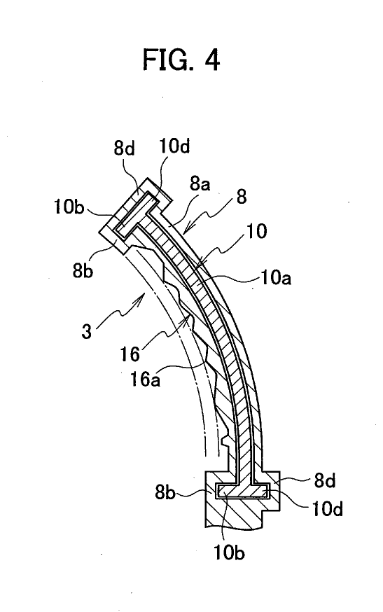

Further, as illustrated in FIG. 4, the front fitting portion 10 may have outer fitting parts 10d extending outward of the housing 2 from the fitting-portion main part 10a. In this case, the front fitting tube portion 8 has outer fitting tube parts 8d which extend outward of the housing 2 from the fitting-tube-portion main part 8a and into which the outer fitting parts 10d are fitted. Forming the outer fitting parts 10d on the front fitting portion 10 (fitting-portion main part 10a) and forming the outer fitting tube parts 8d on the front fitting tube portion 8 (fitting-tube-portion main part 8a) further increase the contact surface between the front fitting portion 10 and the front fitting tube portion 8. This increases the fitting strength between the front fitting portion 10 and the front fitting tube portion 8, improving the rigidity of the housing 2.

What is claimed is:

1. A shift lever device comprising:
a housing adapted to be fixed to a body of a vehicle; and
a shift lever swingably supported by the housing, wherein
the housing has a pair of right and left side walls disposed in parallel and a pair of front and rear connecting walls connecting front portions and rear portions of the pair of right and left side walls, and is separable in a right-left direction at the connecting walls,
the connecting wall has
a fitting portion which protrudes from one of the pair of right and left side walls toward the other side wall and
a fitting tube portion which protrudes from the other side wall toward the one side wall and into which the fitting portion is fitted,
the fitting portion has a fitting-portion main part and an inner fitting part extending inward of the housing from the fitting-portion main part, and
the fitting tube portion has a fitting-tube-portion main part into which the fitting-portion main part is fitted, and an inner fitting tube part which extends inward of the housing from the fitting-tube-portion main part and into which the inner fitting part is fitted.

2. The shift lever device according to claim 1, wherein
the fitting-portion main part and the fitting-tube-portion main part extend along outer edges of the housing.

3. The shift lever device according to claim 1, wherein
the inner fitting tube parts are formed at both ends of the fitting-tube-portion main part, and
a check protrusion is disposed between these inner fitting tube parts.

4. The shift lever device according to claim 1, wherein
the fitting portion has an outer fitting part which extends outward of the housing from the fitting-portion main part, and
the fitting tube portion has an outer fitting tube part which extends outward of the housing from the fitting-tube-portion main part and into which the outer fitting part is fitted.
